(19) United States
(12) Patent Application Publication
(10) Pub. No.: US 2007/0289426 A1
(43) Pub. Date: Dec. 20, 2007

(54) Bolt remover

(76) Inventor: Peter C. Chaconas, Glyndon, MD (US)

Correspondence Address: NELSON MULLINS RILEY & SCARBOROUGH, LLP, 1320 MAIN STREET, 17TH FLOOR, COLUMBIA, SC, 29201, US

(21) Appl. No.: 11/453,948

(22) Filed: Jun. 15, 2006

(51) Int. Cl. G10F 1/02

(52) U.S. Cl. 84/52

(57) ABSTRACT

A fastener removal tool comprising a generally cylindrical body having a central longitudinal axis, a first and second end perpendicular to the central longitudinal axis and a central bore between the first and second ends. The central bore defines a cylindrical inner wall that defines a plurality of equally spaced-apart axial ribs positioned proximate the body first end. Each rib extends radially inward from the central bore inner wall and has a first wall, a second wall, and a third wall that intersects the rib first and second walls. The rib first and second walls converge towards each other in a radial direction and the rib first and second walls converge towards each other in an axial direction. The rib first wall and the rib third wall intersect to form a first bite edge, and the rib second wall and the rib third wall intersect to form a second bite edge.

### BACKGROUND OF THE INVENTION

The present invention relates to a tool for removing bolts, nuts or other types of threaded fastening hardware where the head has been stripped or damaged, or requires a special tool for removal.

In the construction and mechanical industries, threaded fasteners such as bolts, nuts and studs are frequently used to attach structural members together. Threaded fasteners are desirable because they are easy to use and offer the advantage of quick and secure attachment. Threaded fasteners also offer ease of assembly and disassembly for repair or complete teardown. However, such fasteners are frequently damaged due to cross-threading, deformation of the bolt head, severe oxidation, stripping of the threads, or over-tightened during the assembly, disassembly, or repair. In such instances, the use of a conventional socket or wrench may be ineffective or may even aggravate the condition. Accordingly, it is important for mechanics, construction workers, and other skilled trades to be able to loosen and remove such hardware, even when the heads are severely damaged. Additionally, there is a need for a tool that both assists in the removal of damaged fasteners and is compatible with conventional wrenches or socket drivers.

### SUMMARY OF THE INVENTION

The present invention recognizes and addresses considerations of prior art constructions and methods. In an embodiment of the present invention a bolt and nut removal tool comprises a generally cylindrical body having a central longitudinal axis, a first end perpendicular to said central longitudinal axis, a second end perpendicular to said central longitudinal axis, and a central bore proceeding from said first end towards said second end. The central bore defines a generally cylindrical inner wall, wherein said inner wall defines a plurality of equally spaced-apart axial ribs positioned proximate said body first end, and each of said plurality of axial ribs extends radially inward from said central bore inner wall. Each of said plurality of axial ribs has a first wall, a second wall, and a third wall that intersects said rib first wall and said rib second wall, and wherein said rib first wall and said rib second wall converge towards each other in a radial direction and said rib first wall and said rib second wall converge towards each other in an axial direction, and wherein said rib first wall and said rib third wall intersect to form a first bite edge, and said rib second wall and said rib third wall intersect to form a second bite edge.

The accompanying drawings, which are incorporated in and constitute a part of this specification, illustrate one or more embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended drawings, in which:

FIG. 1 is a bottom perspective view of a bolt remover in accordance with an embodiment of the present invention;

FIG. 2 is a top perspective view of the bolt remover of FIG. 1;

FIG. 3 is a perspective cutaway view of the bolt remover of FIG. 2;

FIG. 4 is a bottom view of the bolt remover of FIG. 1;

FIG. 5 is a top view of the bolt remover of FIG. 1;

FIG. 6 is a section view of the bolt remover of FIG. 5 taken through line 6-6;

FIG. 7 is a top perspective view of a bolt remover in accordance with an embodiment of the present invention;

FIG. 8 is a top perspective view of a ratcheting wrench for use with the bolt remover of FIG. 7;

FIG. 9 is a top perspective view of the ratcheting wrench of FIG. 8 and the bolt remover of FIG. 7,

FIG. 10 is a partial perspective cut-away view of the bolt remover of FIG. 7;

FIG. 11 is a bottom perspective view of the bolt remover of FIG. 7;

FIG. 12 is a perspective cutaway view of the bolt remover of FIG. 11 taken through line 12-12;

FIG. 13 is a top view of the bolt remover of FIG. 7;

FIG. 14 is a bottom view of the bolt remover of FIG. 7;

FIG. 15 is a partial sectional view of the bolt remover of FIG. 7;

FIG. 15A is a cross-section view of the bolt remover of FIG. 7;

FIG. 16 is a cross-section view of the bolt remover of FIG. 7;

FIG. 17 is a top perspective view of a bolt remover in accordance with an embodiment of the present invention;

FIG. 18 is a bottom perspective view of the bolt remover of FIG. 17;

FIG. 19 is a perspective cutaway view of the bolt remover of FIG. 18 taken through line 19-19;

FIG. 20 is a top view of the bolt remover of FIG. 17;

FIG. 21 is a bottom view of the bolt remover of FIG. 17;

FIG. 22 is a cross-section view of the bolt remover of FIG. 21 taken through line 22-22;

FIG. 23 is a top perspective view of a bolt remover in accordance with an embodiment of the present invention;

FIG. 24 is a top perspective view of a bolt remover in accordance with an embodiment of the present invention;

FIG. 25 is a bottom perspective view of the bolt remover of FIG. 24;

FIG. 26 is a perspective cutaway view of the bolt remover of FIG. 25 taken through line 26-26;

FIG. 27 is a top view of the bolt remover of FIG. 24;

FIG. 28A is a perspective view of the bolt remover of FIG. 1 shown in operation on the head of a bolt;

FIG. 28B is a perspective view of the bolt remover of FIG. 1 shown in operation on the head of a bolt;

FIG. 29A is a bottom view of the bolt remover of FIG. 1 shown in operation on the head of a bolt;

FIG. 29B is a bottom view of the bolt remover of FIG. 1 shown in operation on the head of a bolt;

FIG. 29C is a bottom view of the bolt remover of FIG. 1 shown in operation on the head of a bolt; and

FIG. 30 is a bottom perspective view of the bolt remover of FIG. 1 shown in operation on the head of a bolt.

Repeat use of reference characters in the present specification and drawings is intended to represent same or analogous features or elements of the invention.

### DETAILED DESCRIPTION OF PREFERRED EMBODIMENTS

Reference will now be made in detail to presently preferred embodiments of the invention, one or more examples of which are illustrated in the accompanying drawings. Each example is provided by way of explanation of the invention, not limitation of the invention. In fact, it will be apparent to those skilled in the art that modifications and variations can be made in the present invention without departing from the scope and spirit thereof. For instance, features illustrated or described as part of one embodiment may be used on another embodiment to yield a still further embodiment. Thus, it is intended that the present invention covers such modifications and variations as come within the scope of the appended claims and their equivalents.

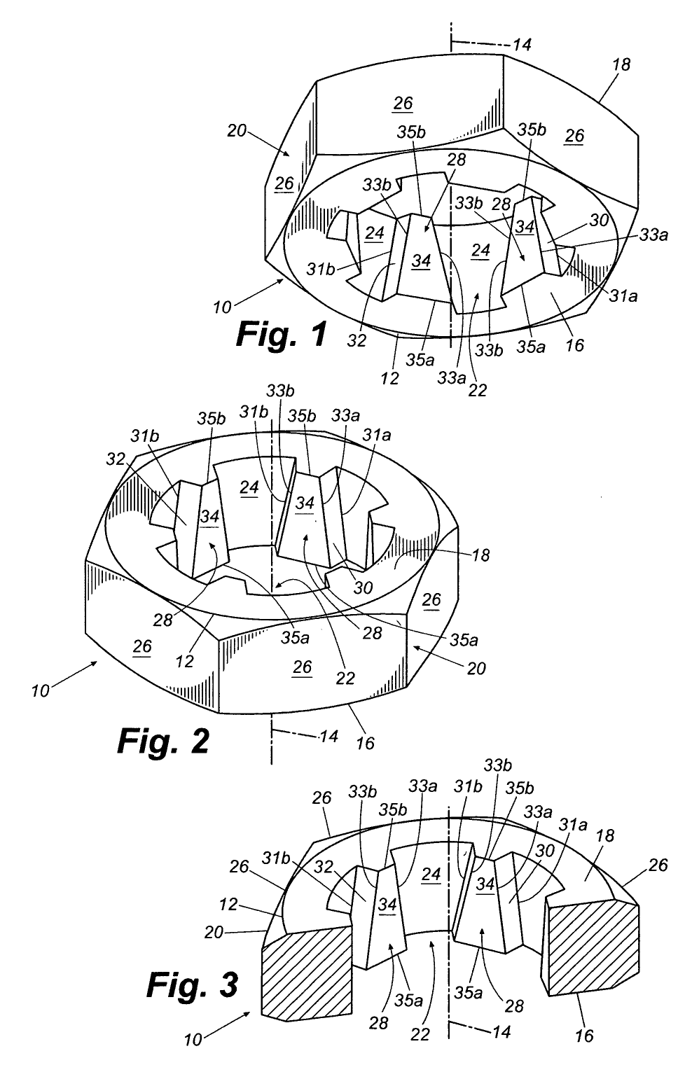

Referring to FIGS. 1-5, a bolt remover 10 is illustrated having a generally cylindrical body 12, a central longitudinal axis 14, a first end 16 (FIGS. 1-4) a second end 18 (FIGS. 1-3 and 5) and an outer wall 20. An axial bore 22 is formed through cylindrical body 12 and extends from first end 16 to second end 18 and defines an inner wall 24. Outer wall 20 may define a plurality of flat sides 26 to allow a wrench or other tool to grip bolt remover 10 and rotate it about central longitudinal axis 14.

Referring in particular to FIG. 2, a plurality of axial ribs 28 are formed on inner wall 24 and extend radially inward into axial bore 22 toward central longitudinal axis 14. Each rib 28 defines a first side wall 30, a second side wall 32, and a third face wall 34. First side wall 30 and second side wall 32 extend radially inward from axial bore inner wall 24 in a direction generally toward central longitudinal axis 14. First side wall 30 and second side wall 32 intersect inner wall 24 to define a pair of corners 31a and 31b, respectively. Third face wall 34 spans between first side wall 30 and second side wall 32, forming a pair of bite edges 33a and 33b located at the intersections of third face wall 34 with first side wall 30 and second side wall 32, respectively.

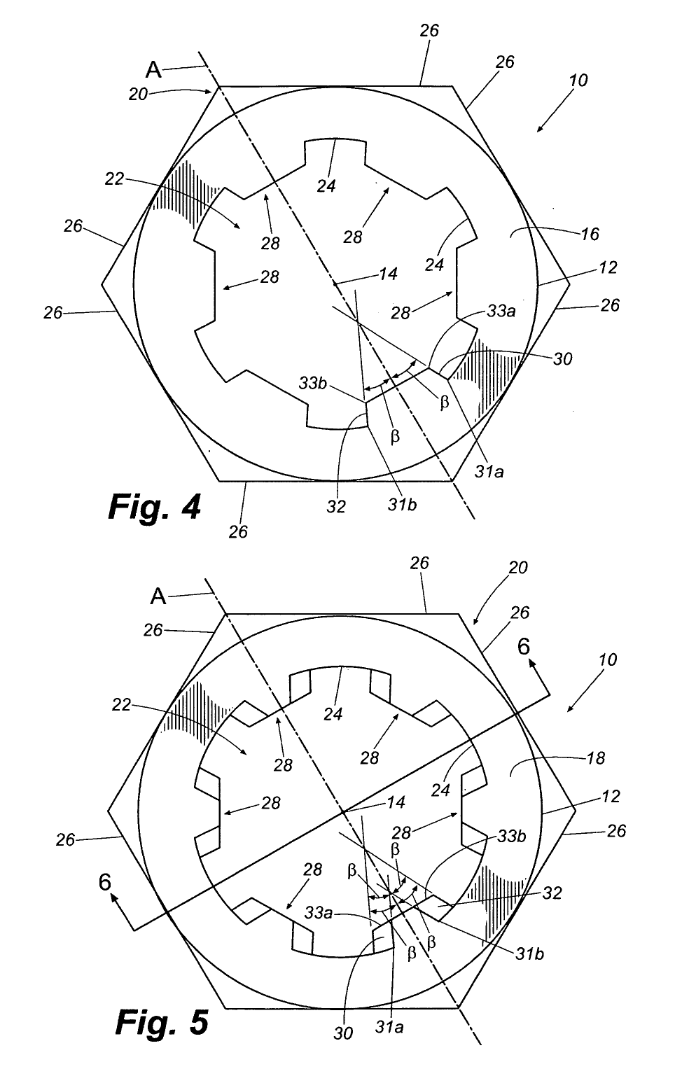

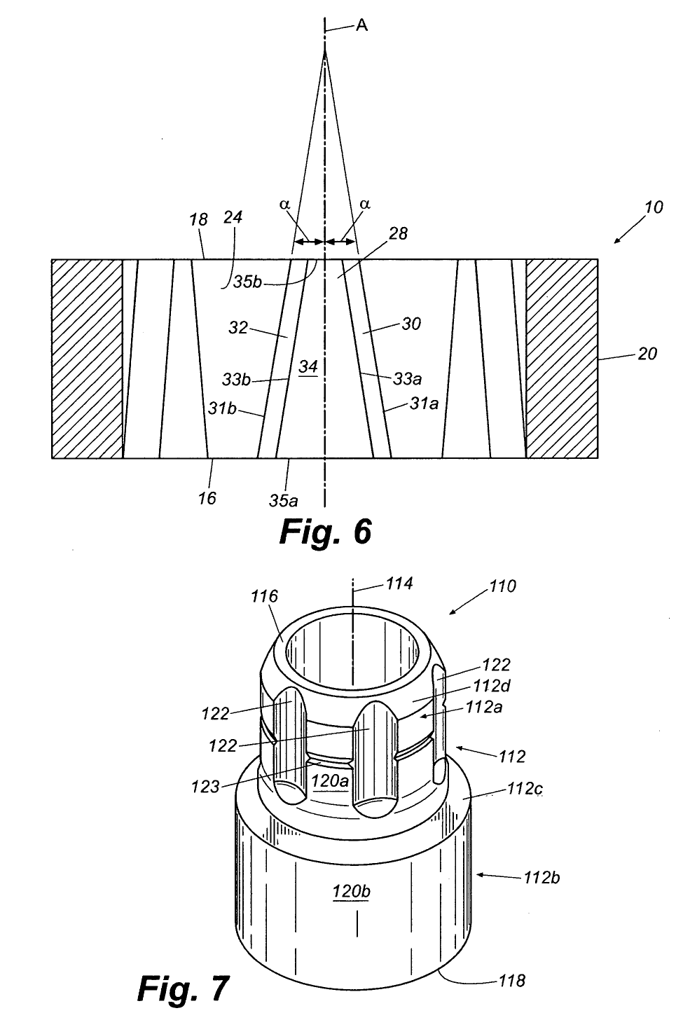

Referring to FIGS. 1-3, third wall 34 defines a first horizontal edge 35a at the intersection between third face wall 34 and first end 16 and a second horizontal edge 35b at the intersection between third face wall 34 and first end 18. Accordingly, bite edges 33a and 33b, and horizontal edges 35a and 35b define the perimeter of third face wall 34. Referring to FIGS. 4 and 5, central longitudinal axis 14 lies along a plane A (shown in phantom) that both bisects and is perpendicular to third face wall 34. In one embodiment, first side wall 30 and second side wall 32 are arranged so that they converge toward plane A along their axial lengths from body first end 16 to body second end 18. Referring with particularity to FIG. 6, both first side wall 30 and second side wall 32 converge toward plane A at a first convergence angle α, which may be in the range of 5 to 40 degrees. Because side walls 30 and 32 are skewed from plane A by first convergence angle α, bite edges 33a and 33b are also disposed at first convergence angle α with respect to plane A in the axial direction. Accordingly, the perimeter of third face wall 34 defined by bite edges 33a and 33b, and horizontal edges 35a and 35b defines a trapezoid. It is also envisioned that first convergence angle α may be so steep that the first and second side walls intersect, giving third face wall 34 a triangular shape as shown in the embodiment of FIGS. 7 and 10-16.

Referring again to FIGS. 4 and 5, rib first side wall 30 and rib second side wall 32 also converge towards plane A at a second convergence angle β, which may be in the range of 0 to 60 degrees. Axial rib first side wall 30 and second side wall 32 taper radially along convergence angle β from corner 31a to bite edge 33a and from corner 31b to bite edge 33b, respectively. In this way, axial ribs 28 each taper axially along convergence angle α (FIG. 4A) and radially along convergence angle β. Thus, the axial ribs have a trapezoidal cross-section taken perpendicular to central longitudinal axis 14.

It should be understood that the bolt remover should be made from a material that is harder than the fastener material, e.g. 6140 or 4140 alloy steels for the bolt remover and 1035 alloy steel for the fastener. Preferably, there is a 10 point or greater hardness differential between the bolt remover material and the fastener material.

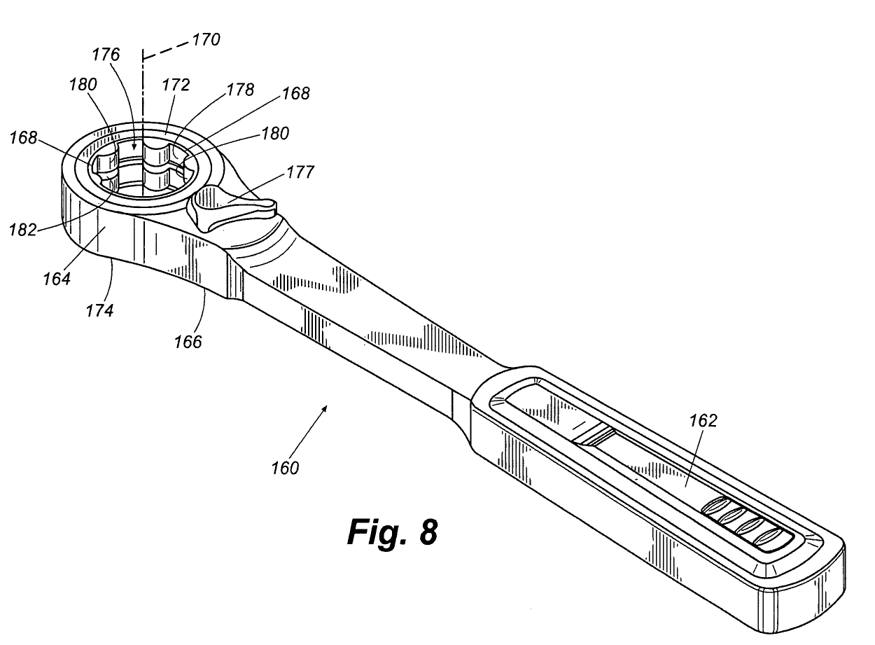

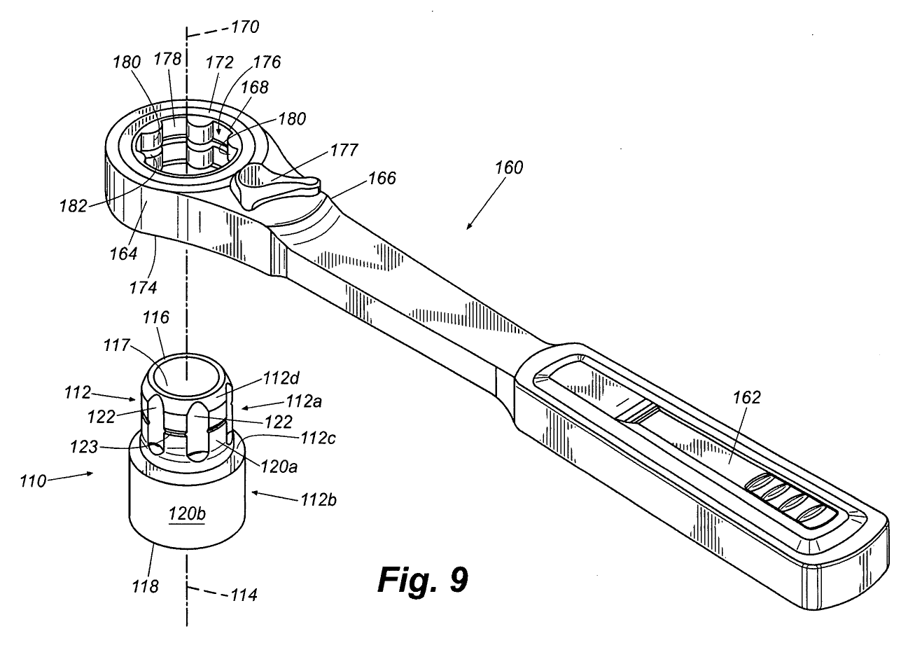

Referring to FIGS. 7 and 9-12, another embodiment of a bolt remover 110 for use with a ratcheting wrench 160 (FIGS. 8 and 9) is illustrated having a body 112, a central longitudinal axis 114, a first end 116 and a second end 118. Body 112 may have a generally cylindrical first section 112a proximate to body first end 116, a generally cylindrical second section 112b proximate to body second end 118, a third section 112c intermediate the first and second sections, and a chamfered section 112d intermediate the first section and body first end 116. Body second section 112b has a generally cylindrical outer wall 120b, while body first section 112a has generally cylindrical outer wall 120a that defines a plurality of equi-spaced arcuate longitudinal recesses 122.

Referring to FIGS. 8 and 9, ratcheting wrench 160 has a handle 162, a head 164 and a neck 166 intermediate handle 162 and head 164. Ratcheting wrench head 164 includes a ratcheting ring 168 having a central axis 170, a first end 172, a second end 174, an axial bore 176, and a direction selector switch 177. Axial bore 176 defines an inner ratcheting ring wall 178 and a plurality of equi-spaced arcuate ribs 180 that protrude radially inward from ring wall 178 towards ring central axis 170. Ribs 180 are equally sized appropriately to cooperate with recesses 122 (FIGS. 7, and 9-11), and axial bore 176 is sized appropriately to receive bolt remover body first section 112a as depicted in FIG. 9. Ratcheting ring wall 178 also defines an annular groove 182 that receives a compressible C-ring (not shown) positioned intermediate ratcheting ring first end 172 and ratcheting ring second end 174.

Referring again to FIGS. 7 and 9-11, bolt remover body first section outer wall 120a also defines an annular groove 123 positioned intermediate body third section 112c and body chamfered section 112d. Annular groove 123 is sized appropriately to releasably receive ratcheting wrench C-ring (not shown). Referring to FIG. 9, when bolt remover 110 is inserted into ratcheting wrench axial bore 176, body chamfered section 112d compresses the ratcheting wrench C-ring, and bolt remover recesses 122 each receive a respective wrench arcuate rib 180. Once bolt remover 110 is inserted far enough into ratcheting ring 168 for annular groove 123 to receive the wrench C-ring, the C-ring expands into bolt remover annular groove 123. In this way, the C-ring is simultaneously received in ratchet wrench annular groove 182 and bolt remover annular groove 123, creating a releasable locking connection between bolt remover 110 and ratcheting ring 168. In this configuration, bolt remover 110 is axially and rotationally fixed to ratcheting ring 168 and may rotate with the ratcheting ring as a unitary assembly with respect to ratcheting wrench head 164.

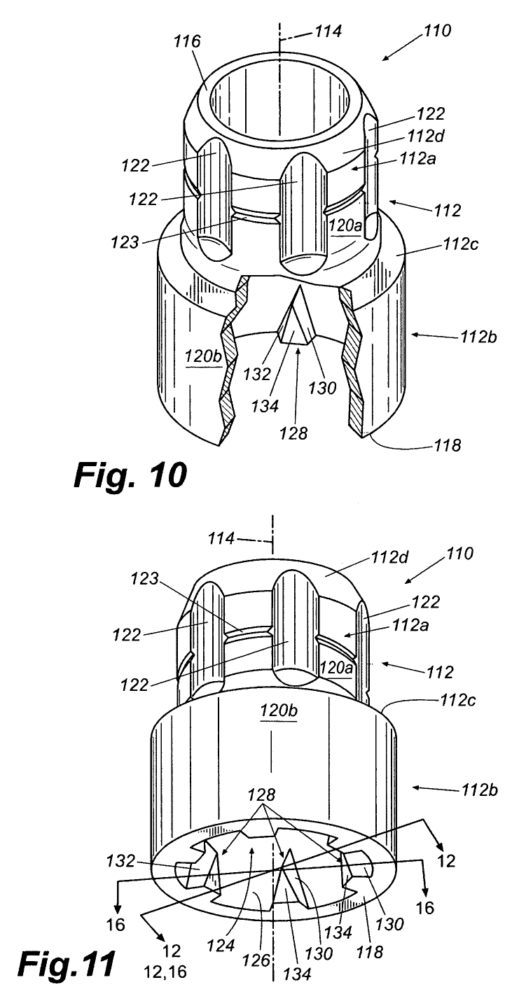

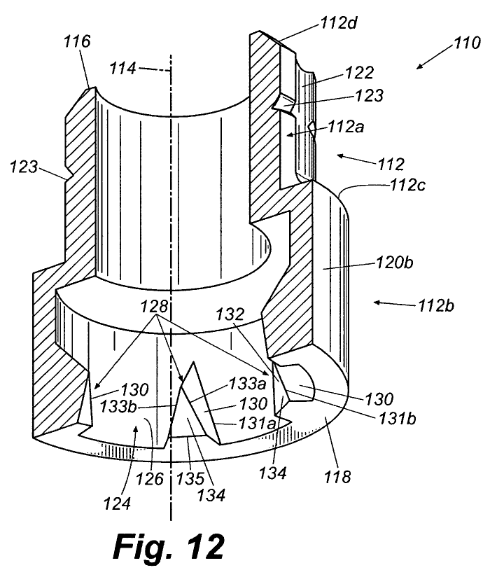

Referring to FIGS. 11 and 12, an axial bore 124 is formed through bolt remover 110 extending from body second end 118 to body first end 116. Axial bore 124 defines an inner wall 126 that further defines a plurality of axial ribs 128 that extend radially inward from inner wall 126 into axial bore 124. Referring to FIGS. 10 and 11, each rib 128 defines a first side wall 130 and a second side wall 132 that extend radially inward from inner wall 126 in a direction generally toward central longitudinal axis 114, and a third face wall 134. Referring to FIGS. 12 and 14, first side wall 130 and second side wall 132 intersect inner wall 126 to define a pair of corners 131a and 131b (FIG. 12), respectively. Third wall 134 spans between first side wall 130 and second side wall 132 forming a pair of bite edges 133a and 133b located at the intersections of third face wall 134 with first side wall 130 and second side wall 132, respectively. Third face wall 134 defines a horizontal edge 135 formed at the intersection between third face wall 134 and body second end 118. Accordingly, bite edges 133a, 133b and horizontal edge 135 define the perimeter of third face wall 134.

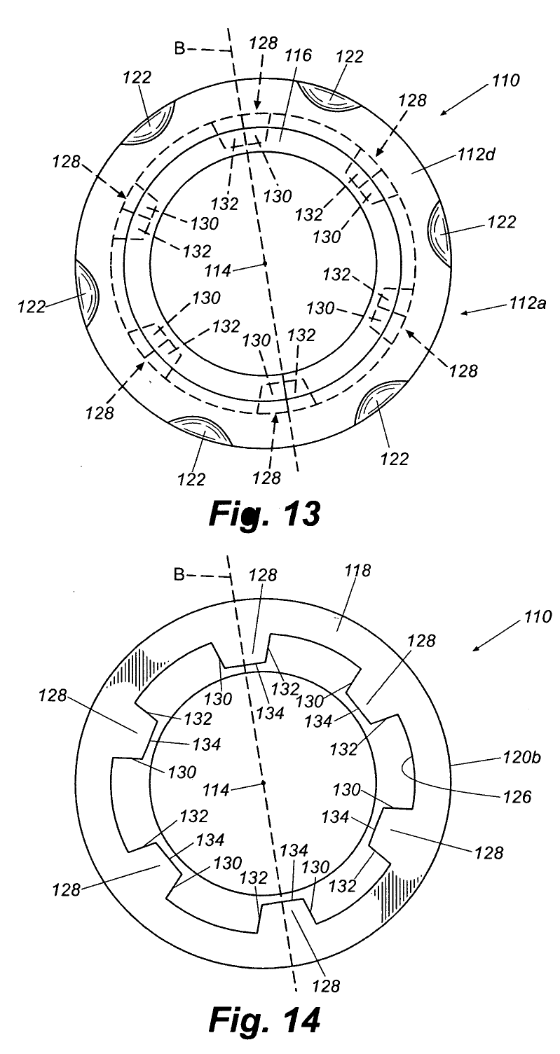

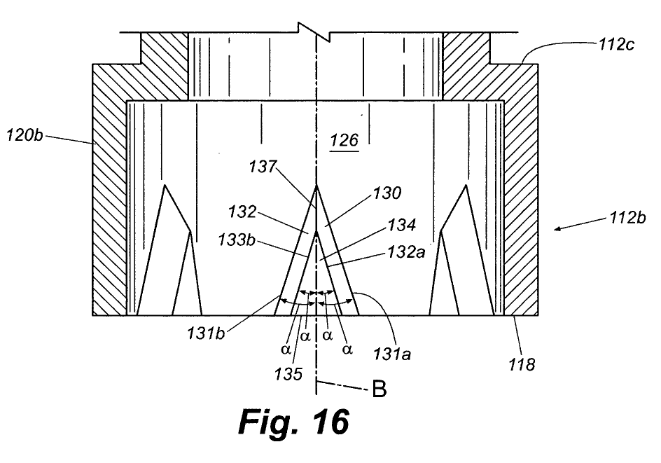

Central longitudinal axis 114 (FIGS. 13 and 14) lies along a plane B (shown in phantom) that both bisects and is perpendicular to third face wall 134. In one embodiment, first side wall 130 and second side wall 132 are arranged so that they converge toward plane B in the axial direction. Referring with particularity to FIG. 16, both first side wall 130 and second side wall 132 converge toward plane B at first convergence angle α. Because side walls 130 and 132 are skewed from plane B by first convergence angle α, bite edges 133a and 133b are also disposed at first convergence angle α with respect to plane B so that the side walls intersect at an edge 137 that lies along plane B. Accordingly, the perimeter of third face wall 134 defined by bite edges 133a, 133b and horizontal edge 135 defines a triangle. It is also envisioned that the first and second rib side walls will not intersect, but instead terminate at a position intermediate edge 137 and edge 135 forming a third face wall 134 having a perimeter in the shape of a trapezoid.

Referring to FIGS. 13 and 14, first side wall 130 and second side wall 132 also converge towards plane B at a second convergence angle β in the radial direction. That is, the axial rib first and second side walls taper along convergence angle β from corner 131a to bite edge 133a and from corner 131b to bite edge 133b, respectively. In this way, axial ribs 128 each taper axially along convergence angle α (FIG. 11A) and radially along convergence angle β so that the rib has a trapezoidal cross-section perpendicular to central longitudinal axis 14.

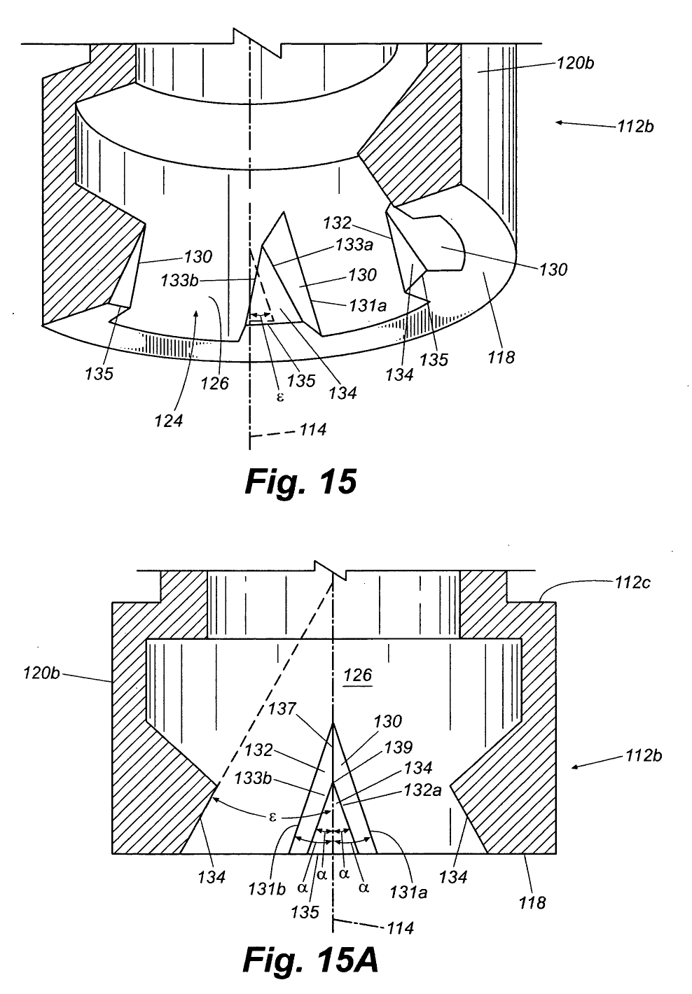

Bolts and nuts become stripped when the user applies excessive torque to the bolt or nut when tightening it. In most instances, stripping of the bolt head or nut occurs when the tool used to apply torque slips off of the bolt head or nut causing the portion of the sidewalls and corners to shear and become rounded. As such, the bolt head or nut usually takes on a conical shape, wider at the base and narrower in diameter distal from the base. Thus, to ensure maximum grip on the stripped bolt head or nut, it is advantageous to increase the contact between the bolt remover and the side walls of the bolt head or nut. Referring to FIGS. 15 and 15A, third face wall 134 may converge toward central longitudinal axis 114 at an angle ε, which may be in the range of 0 to 30 degrees depending on the application of the bolt remover. That is, third face wall 134 is angled inward from end 118 toward end 116 such that the distance between the central longitudinal axis and a vertex 139 of the third face wall proximate to end 116 is less than the distance between the central longitudinal axis and third face wall horizontal edge 135. This embodiment is particularly useful because rib bite edges 133a and 133b also converge along angle ε so that the entire length of the bite edges will engage the sidewalls of a bolt head that may have been sheared or stripped into a generally conical shape, thereby increasing the engagement area between rib first wall 130 or second wall 132 with the sidewalls of the bolt head. Accordingly, a bolt remover having bite edges 133a and 133b disposed along angle ε will be less likely to further damage the bolt head and more easily loosen the damaged bolt head. Additionally, the angled bite edges will eliminate the need to use a smaller bolt remover in the event that the bolt head is severely damaged.

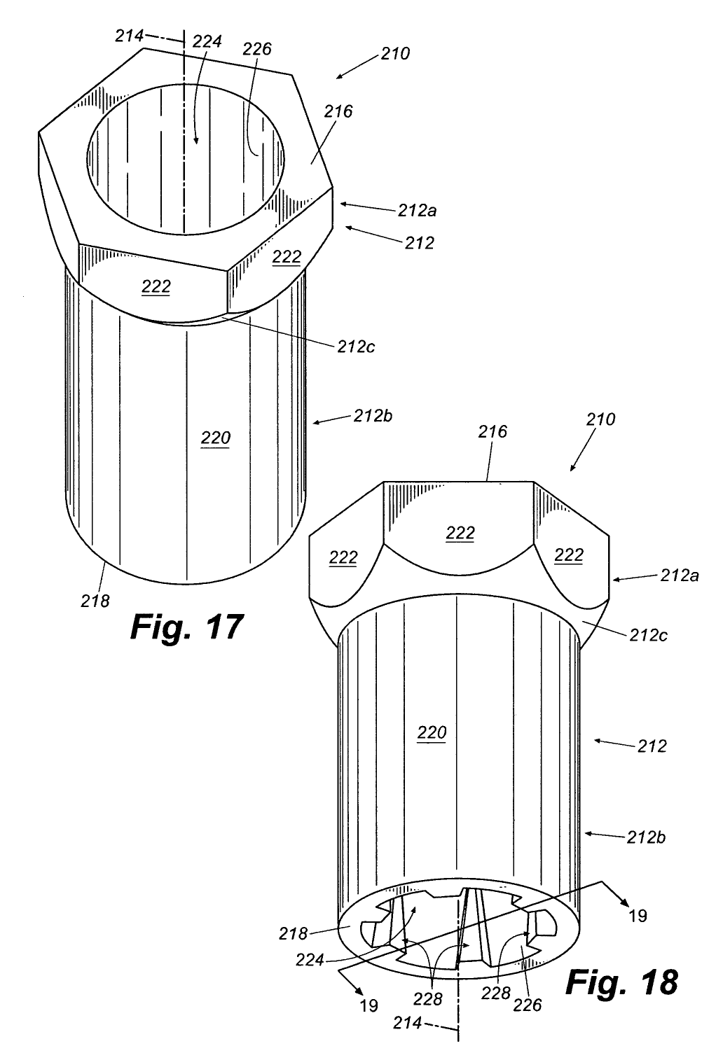

Referring to FIGS. 17-19, a bolt remover 210 is illustrated having a body 212, a central longitudinal axis 214, a first end 216, and a second end 218. Body 212 may have a first section 212a proximate to body first end 216, a generally cylindrical second section 212b proximate to body second end 218, and a third section 212c intermediate the first and second sections. Body second section 212b has a generally cylindrical outer wall 220, while body first section 212a has a polygonal outer surface defined by a plurality of flat sides 222 that allow a wrench or other tool to grip bolt remover 210 and rotate it about central longitudinal axis 214. Body third section 212c forms a transition region between the polygonal outer surface of body first section 212a and the generally cylindrical outer wall of body second section 212b. An axial bore 224 is formed through body 212, extends from body first end 216 to body second end 218, and defines an inner wall 226. It should be understood that body first end 216 may define a square opening that receives a tang on a socket wrench as shown in FIG. 23. In particular, recess 236 receivably accepts the drive tang from a power driver or a hand-held ratcheting driver (not shown). Such drive tangs are commonly used in connection with sockets, universal joint drivers, and other similar torque transmitting tools. FIG. 23 shows a tang receiving recess 236 having a generally square perimeter, but it should be recognized that recess 236 may be shaped appropriately to receive a drive tang having any shape, for instance a torx shape. Additionally, bolt remover 210 may also be formed with the configuration disclosed in FIGS. 9-12 such that the bolt remover is received in the ratcheting ring of a ratchet wrench.

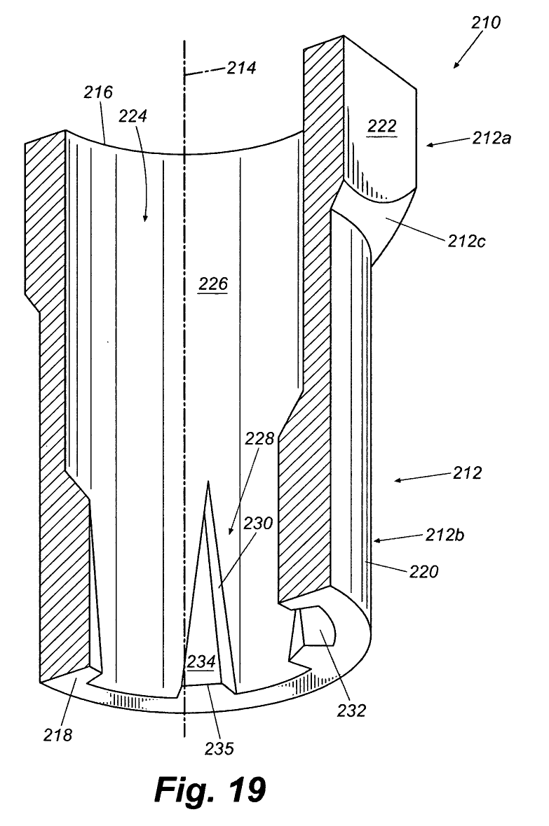

Referring to FIGS. 19-22, a plurality of axial ribs 228 are formed on inner wall 226 and extend radially inward from inner wall 226 into axial bore 224. Each rib 228 defines a first side wall 230, a second side wall 232, and a third face wall 234. Referring to FIG. 21, first side wall 230 and second side wall 232 extend radially inward from inner wall 224 towards central longitudinal axis 214 and intersect inner wall 226 to define a pair of corners 231a and 231b, respectively. Third face wall 234 spans between first side wall 230 and second side wall 232 forming a pair of bite edges 233a and 233b located at the intersections of third face wall 234 with first side wall 230 and second side wall 232, respectively. Third face wall 234 defines a horizontal edge 235 (FIGS. 19, 21, and 22) formed at the intersection between third face wall 234 and body second end 218. Accordingly, bite edges 233a, 233b and horizontal edge 235 define the triangular-shaped perimeter of third wall 234.

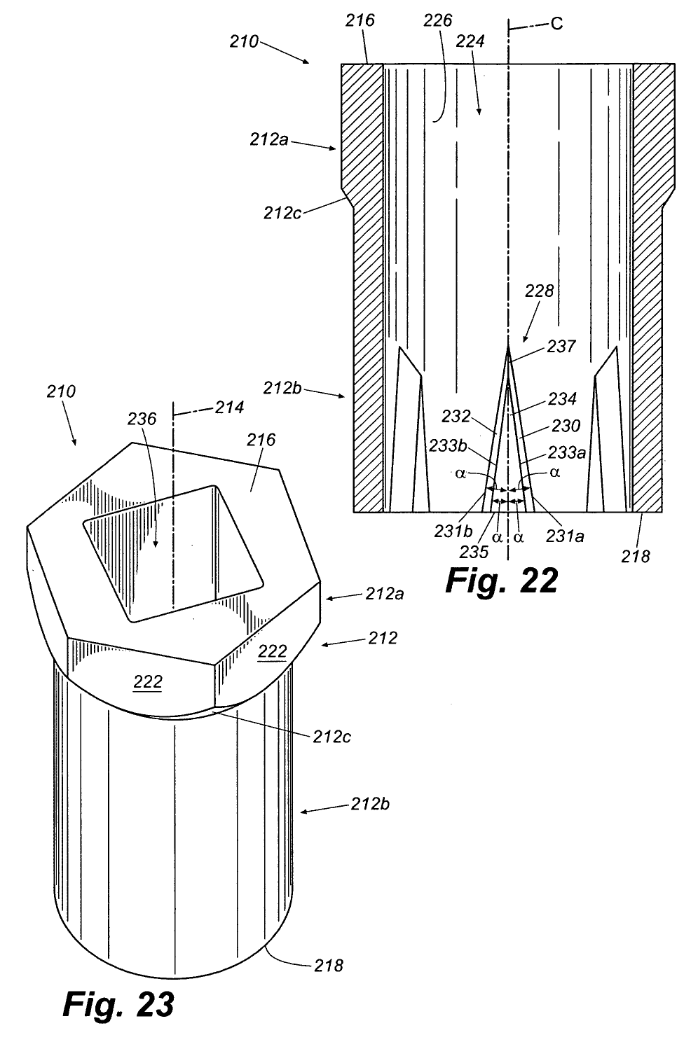

Referring to FIG. 21, central longitudinal axis 214 lies along a plane C (shown in phantom) that both bisects and is perpendicular to rib third face wall 234. In one embodiment, first side wall 230 and second side wall 232 are arranged so that they converge toward plane C in the axial direction at a first convergence angle α (FIG. 22). Referring to FIG. 22, because side walls 230 and 232 are skewed from Plane C by first convergence angle α, corners 231a and 231b and edges 233a and 233b are also disposed at first convergence angle α with respect to Plane C and intersect at edge 237 (FIG. 22). The perimeter of third wall 234 defined by edges 233a, 233b, and 235 defines a triangle. It is also envisioned that the first and second rib side walls terminate at a position intermediate edge 235 and edge 237 so that they do not intersect thereby forming a third face wall 234 having a perimeter in the shape of a trapezoid.

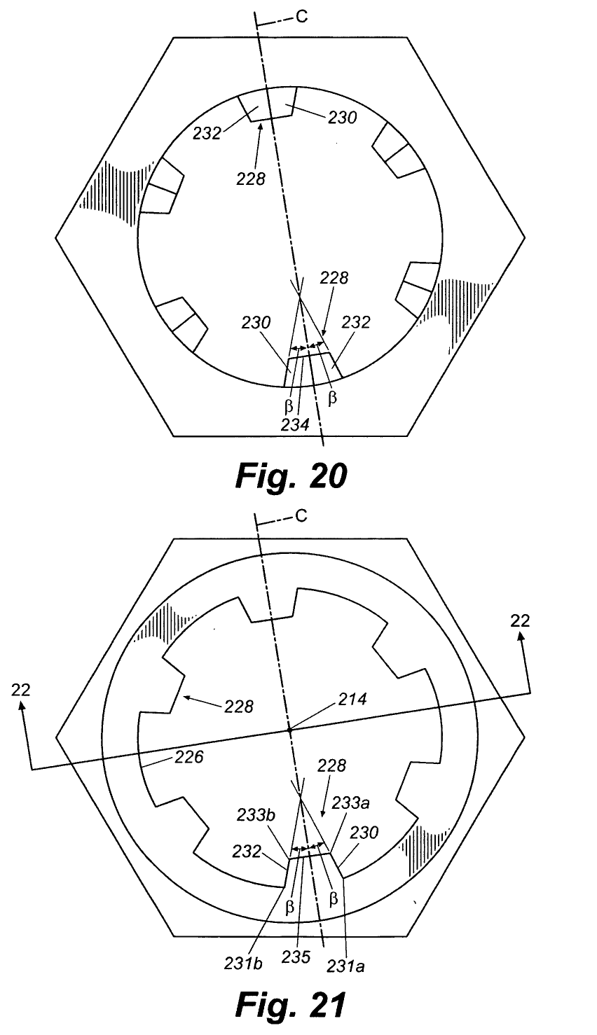

Referring again to FIGS. 20 and 21, first side wall 230 and second side wall 232 also converge in the radial direction towards plane C at a second convergence angle β. The axial rib first and second side walls taper along convergence angle β from corner 231a to bite edge 233a and from corner 231b to bite edge 233b, respectively (FIG. 22). In this way, each axial rib has a cross section transverse to third face wall 234 having a trapezoidal shape.

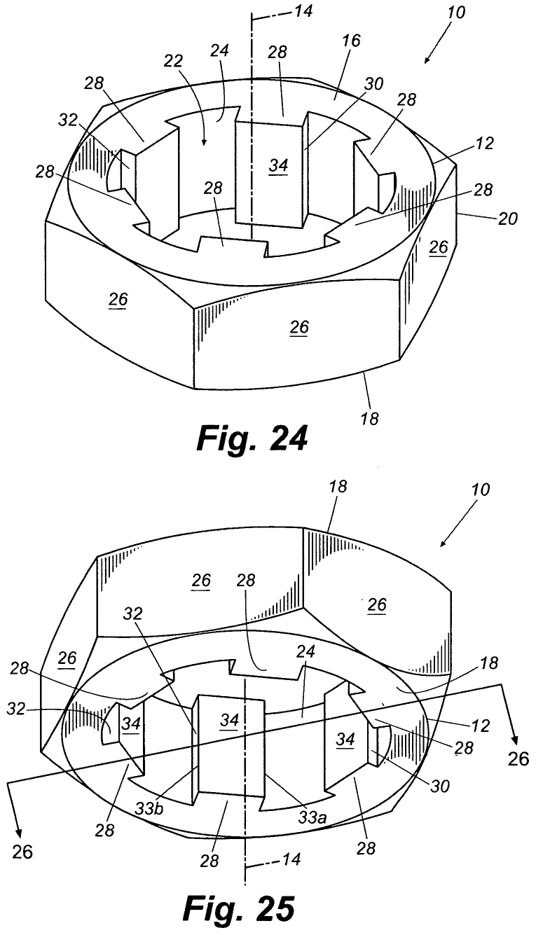

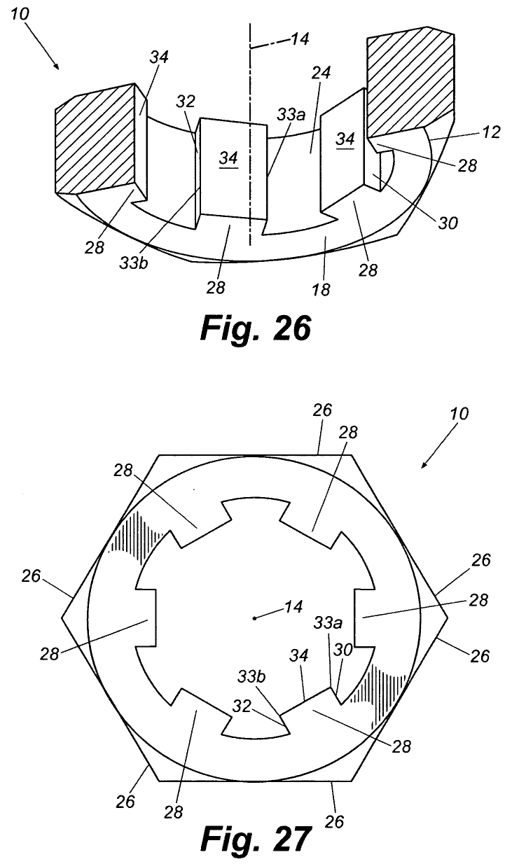

Referring to FIGS. 24-27, an alternative embodiment of driver 10 is shown where each axial rib 28 defines a first side wall 30, a second side wall 32, and a third face wall 34 that are all parallel to central longitudinal axis 14. First wall 30 and second wall 32 also do not converge with respect to each other, but rather are parallel to each other. Additionally, bite edges 33a and 33b are also parallel to each other and to central longitudinal axis 14. Accordingly, third face wall 34 is perpendicular to both first side wall 30 and second side wall 32, and the side walls do not converge toward central longitudinal axis 14.

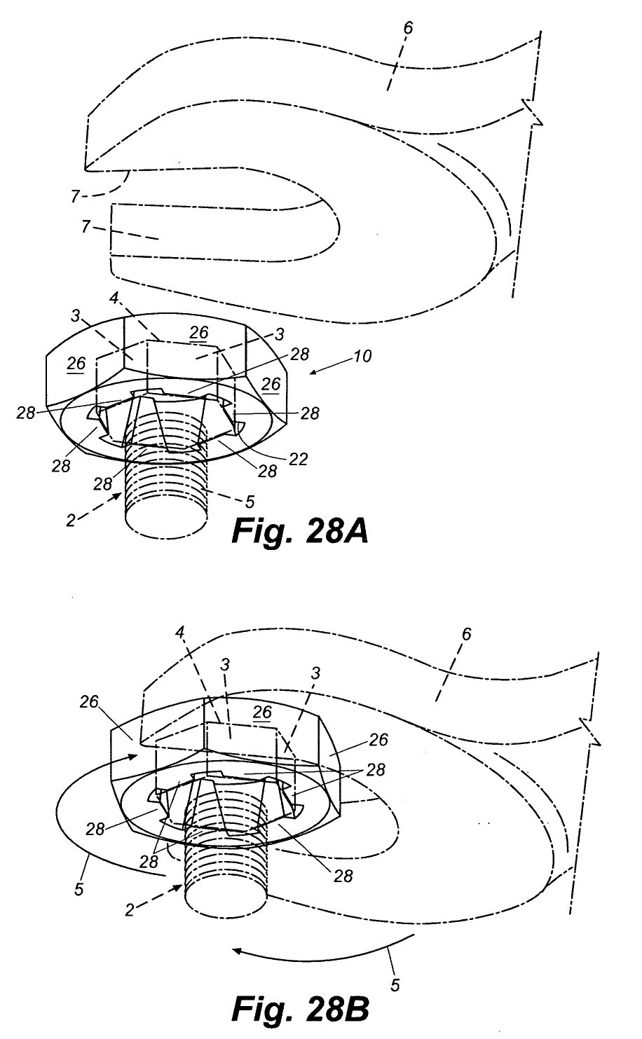

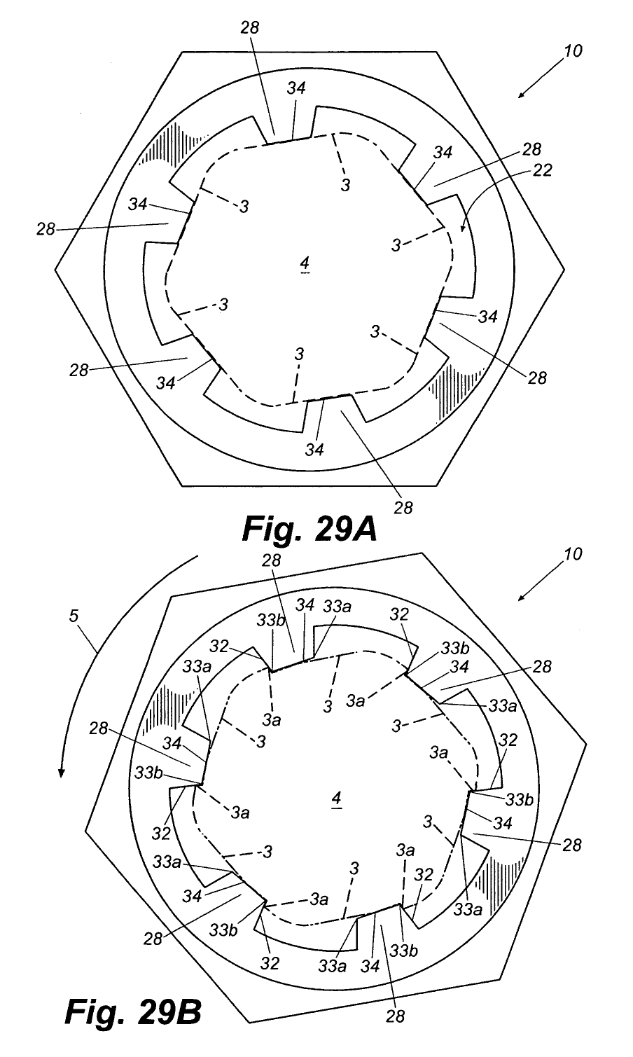

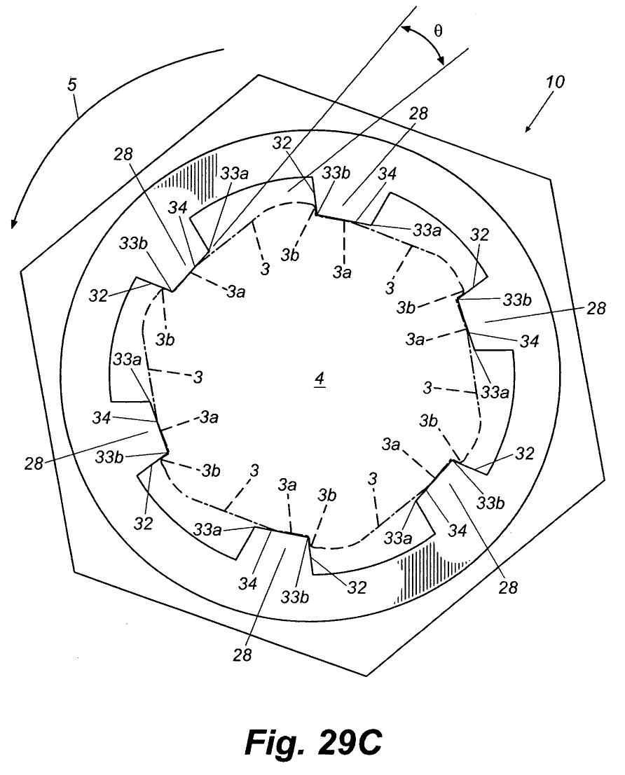

Referring to FIGS. 28A-30, the operation of the bolt remover will be described. It should be understood that the operation of bolt remover 10 is shown using the embodiment depicted FIGS. 1-8, but any other embodiment may be substituted with substantially the same result. Referring to FIG. 28A, a bolt 2 is equipped with a stripped head 4 that is slidably inserted into axial bore 22 of bolt remover 10 so that rib third face walls 34 engage bolt flat sides 3. Alternatively, if bolt 2 is a carriage bolt or other similar form of bolt where head 4 has no flat sides, bolt remover 10 may be applied to a nut (not shown) that has been tightened onto the bolt, with bolt remover ribs 28 engaging the flats of the nut. An operator may use a wrench 6 having two flats 7 sized appropriately to engage bolt remover flat sides 26 to rotate bolt remover 10 and loosen the bolt or nut. FIGS. 29A-29B show wrench 6 as an open-ended wrench, but it should be understood that box-end wrenches, ratchet sockets large enough to accommodate bolt remover flats 26, or other similar driving tools may be selected to drive bolt remover 10.

Referring to FIGS. 29A-29C, bolt remover 10 is shown in operative engagement with bolt head 4 (shown in phantom), but wrench 6 is not shown for purposes of clarity. It should be understood, however, that a tool is used that imparts torque upon the bolt remover. Referring to FIG. 29A, the bolt remover ribs engage bolt head 4 by means of contact between third face walls 34 and bolt head flat sides 3 as the bolt head is inserted into bolt remover axial bore 22.

Referring in particular to FIGS. 29B and 29C, as bolt remover 10 rotates in direction 5 and bolt head 4 resists the rotation, axial rib bite edges 33b begin to dig into bolt head flat sides 3 and deform the flat sides resulting in the development of gouge regions 3a in the surface of flat sides 3. As bolt remover bite edges 33b dig further into the gouge regions 3a, the material removed from bolt head flat sides 3 is displaced into deformation regions 3b (FIG. 29C). As wrench 6 (FIGS. 28A and 28B) continues to apply additional torque to bolt remover 10, more material is removed from gouge regions 3a and displaced into deformation regions 3b, and the sides of the deformation regions begin to engage rib second wall 32 allowing axial ribs 28 to increase their grip upon bolt head 4. Referring in particular to FIG. 29C, the development of gouge regions 3a and deformation regions 3b in bolt head flat sides 3 allows bolt remover 10 to rotate relative to bolt head 4 through a relative rotation angle θ.

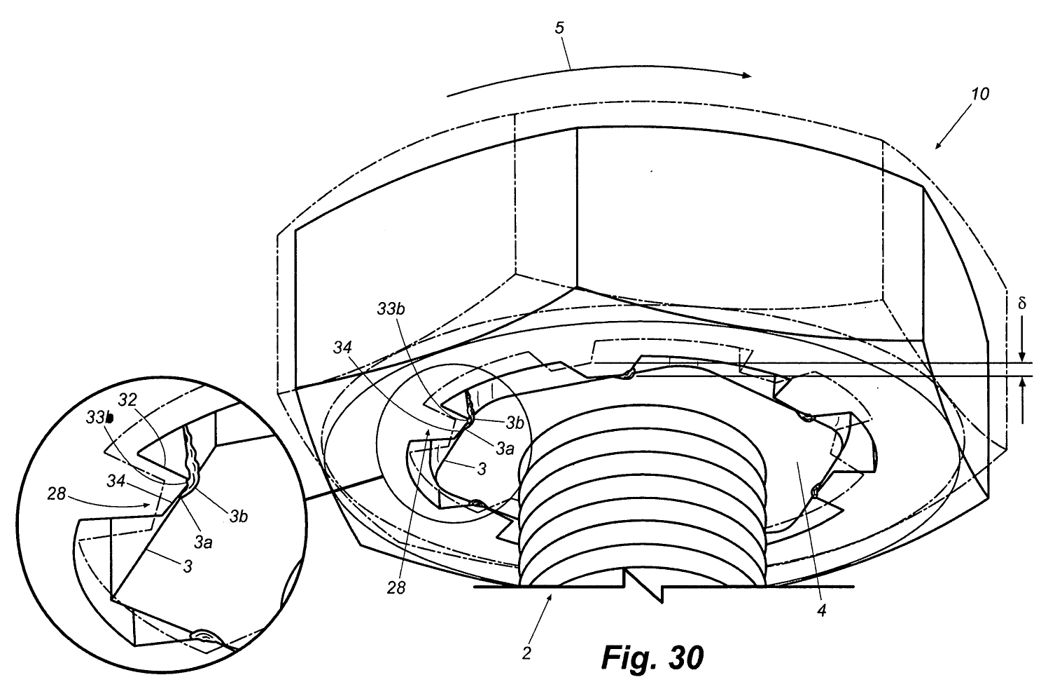

Referring now to FIG. 30, as the deformation regions increase in size, the contact area between the walls of the deformation regions and rib second side walls 32 increase, and relative rotation angle θ also increase. The increased contact area between rib second side walls 32 and bolt head deformation regions 3b reduces the cutting effect of bite edges 33b and increases the torque imparted by bolt remover 10 upon bolt head 4. This phenomenon ensures that the bolt remover 10 will eventually impart a sufficient torque upon bolt head 4 to loosen and unscrew bolt 2 (FIGS. 28A and 28B). It should be understood that rotation of bolt remover 10 in a direction opposite to direction 5 would result in a similar phenomenon, with bite edges 33a engaging bolt head flat sides 3. Such an application would be advantageous for left-hand or reverse threaded bolts, which are frequently used to secure rotating parts such as circular saw blades.

Referring to FIG. 30, axial ribs 28 have both a first convergence angle α (FIG. 6) and a second convergence angle β (FIGS. 4 and 5) with respect to plane A (FIGS. 4, 5 and 6), where first convergence angle α defines an axial taper between rib first side wall 30 and rib second side wall 32 (FIG. 6). Operation of the bolt remover on seized or partially stripped bolts and nuts may require the application of extremely high amounts of torque to break the bolt or nut free. When such a high torque is imparted to bolt head 4, bolt remover 10 will tend to slip off of the bolt head. However, the axial taper of axial ribs 28 reduces the likelihood of slippage between the bolt remover and the bolt head during operation. That is, as wrench 6 (FIGS. 28A and 28B) applies torque to bolt remover 10, the bolt remover rotates with respect to bolt head 4 through relative rotation angle θ (FIG. 29C). This relative rotation causes axial rib second side wall 32 and bite edge 33b to impart a rotational force on bolt head flat side 3 at deformation region 3a. The taper of both second side wall 32 and bite edge 33b at angle α helps to ensure that the rotational force is applied normal to the surface of rib second side wall 32, and causes second side wall 32 to act similarly to the inclined threads of a screw. As described above, bite edge 33b digs into bolt head flat sides 3 at angle α with respect to the central longitudinal axis of the bolt remover creating gouge regions 3a and deformation regions 3b along angle α. Accordingly, as torque is applied to bolt remover 10, the contact forces imparted at the contact area between rib second walls 32 and deformation regions 3b are applied at an angle complimentary to angle α, and second wall 32 and bite edge 33b will pull the bolt remover downward onto the bolt head through a distance δ FIG. 30) as the bolt remover rotates relative to the bolt head. This phenomenon is similar to a screw that advances into a workpiece with each angular rotation of the screw head. In this way, as deformation region 3a increases in size, the engagement between bolt remover 10 and bolt head 4 increases, ensuring that the bolt remover will not slip of the bolt head as wrench 6 (FIGS. 28A and 28B) applies an increasing amount of torque.

While one or more preferred embodiments of the invention have been described above, it should be understood that any and all equivalent realizations of the present invention are included within the scope and spirit thereof. The embodiments depicted are presented by way of example only and are not intended as limitations upon the present invention. Thus, it should be understood by those of ordinary skill in this art that the present invention is not limited to these embodiments since modifications can be made. For example, any of the embodiments may include a tapered or angled third wall, a square drive tang recess, or a first body portion shaped appropriately for use with a ratcheting wrench. Therefore, it is contemplated that any and all such embodiments are included in the present invention as may fall within the scope and spirit thereof.

What is claimed:

1. A bolt and nut removal tool comprising a generally cylindrical body having:
(a) a central longitudinal axis,
(b) a first end perpendicular to said central longitudinal axis,
(c) a second end perpendicular to said central longitudinal axis, and
(d) a central bore extending from said first end towards said second end, said central bore defining a generally cylindrical inner wall defining a plurality of equally spaced-apart axial ribs positioned proximate said body first end, each of said plurality of axial ribs extending radially inward from said central bore inner wall and having
(i) a first side wall,
(ii) a second side wall, and
(iii) a third face wall, intersecting said rib first side wall and said rib second side wall,
wherein
said rib first side wall and said rib second side wall converge towards each other in a radial direction toward said central longitudinal axis and said rib first side wall and said rib second side wall converge towards each other in an axial direction toward said body second end, and
said rib first side wall and said rib third face wall intersect to form a first bite edge, and said rib second side wall and said rib third face wall intersect to form a second bite edge, each said bite edge being angled with respect to said central longitudinal axis.

2. The bolt and nut removal tool of claim 1, wherein said body defines an outer wall extending from said body first end to said body second end having a plurality of flat side surfaces, each said outer wall flat side surfaces extending from said body first end to said body second end and being parallel to said central longitudinal axis.

3. The bolt and nut removal tool of claim 1, wherein said axial rib first side wall and said axial rib second side wall converge towards each other in an axial direction but do not intersect so that said axial rib third face wall defines a generally trapezoidal shape.

4. The bolt and nut removal tool remover of claim 1, wherein said axial rib first side wall and said axial rib second side wall converge towards each other in an axial direction and intersect so that said axial rib third face wall defines a generally triangular shape.

5. The bolt and nut removal tool of claim 1, said generally cylindrical body further comprising
(a) a first section proximate to said body first end,
(b) a second section proximate to said body second end, and
(c) a third section intermediate said body first and second sections,
wherein
said body first section defines an outer wall having a plurality of flat side surfaces that extend from said body first end to a position intermediate said body first end and said body third section and each said flat side surface is parallel to said body central longitudinal axis,
said body second section defines a generally cylindrical outer wall extending from said body second end to a position intermediate said body second end and said body third section, and
said body third section defines an outer surface providing a transition between said body first section outer wall and said body second section outer wall.

6. The bolt and nut removal tool of claim 1, said generally cylindrical body further comprising
(a) a first section proximate to said body first end,
(b) a second section proximate to said body second end, and
(c) a third section intermediate said body first and second sections,
wherein
said body first section defines a generally cylindrical outer wall having a plurality of equally spaced apart arcuate longitudinal recesses extending from a position proximate to said body first end and terminating at a position intermediate said body first end and said body third section,
said body first section outer wall further defines an annular groove intermediate said body first end and said body third section,
said body second section defines a generally cylindrical outer wall extending from said body second end to a position intermediate said body second end and said body third section, and
said body third section defines an outer surface providing a transition between said body first section outer wall and said body second section outer wall.

7. The bolt and nut removal tool of claim 1, said body second end further comprising a generally square axial recess formed therein that is sized appropriately to releasably receive a drive tang from a torque-imparting driving tool.

8. The bolt and nut removal tool of claim 7 wherein said body first end generally square axial recess communicates with said body central bore.

9. The bolt and nut removal tool of claim 1 wherein said third face wall is angled radially inward with respect to said central longitudinal axis from said body first end toward said body second end.

10. A bolt and nut removal tool comprising a generally cylindrical body comprising:
(a) a first end,
(b) a second end,
(c) an outer wall extending between said first and second ends,
(d) a central longitudinal axis, and
(e) a central bore extending from said first end towards said second end, said central bore defining a generally cylindrical inner wall that defins a plurality of equally spaced-apart axial ribs positioned proximate said body first end, each of said axial ribs extending radially inward from said central bore inner wall and having
(i) a first side wall extending radially inward from said central bore inner wall,
(ii) a second side wall extending radially inward from said central bore inner wall, and
(iii) a third face wall intersecting said rib first side wall and said rib second side wall,
wherein
said rib first side wall and said rib second side wall extend radially inward parallel to each other and parallel to said central longitudinal axis,
said third face wall is perpendicular to both said first side wall and said second side wall, and
said rib first side wall and said rib third face wall intersect to form a first bite edge, and said rib second side wall and said rib third face wall intersect to form a second bite edge.

11. The bolt and nut removal tool of claim 10, wherein said outer wall defines a plurality of flat side surfaces, each said outer wall flat side surface extending from said body first end to said body second end and being parallel to said central longitudinal axis.

12. The bolt and nut removal tool of claim 10, said generally cylindrical body further comprising
(a) a first section proximate to said body first end,
(b) a second section proximate to said body second end, and
(c) a third section intermediate said body first and second sections,
wherein
said body first section defines an outer wall having a plurality of flat side surfaces that extend from said body first end to a position intermediate said body first end and said body third section and each said flat side surface is parallel to said body central longitudinal axis,
said body second section defines a generally cylindrical outer wall extending from said body second end to a position intermediate said body second end and said body third section, and
said body third section defines an outer surface providing a transition between said body first section outer wall and said body second section outer wall.

13. The bolt and nut removal tool of claim 10, said generally cylindrical body further comprising
(a) a first section proximate to said body first end,
(b) a second section proximate to said body second end, and
(c) a third section intermediate said body first and second sections,
wherein
said body first section defines a generally cylindrical outer wall having a plurality of equally spaced apart arcuate longitudinal recesses extending from a position proximate to said body first end and terminating at a position intermediate said body first end and said body third section,
said body first section outer wall further defines an annular groove intermediate said body first end and said body third section,
said body second section defines a generally cylindrical outer wall extending from said body second end to a position intermediate said body second end and said body third section, and
said body third section defines an outer surface providing a transition between said body first section outer wall and said body second section outer wall.

14. The bolt and nut removal tool of claim 10, said body second end further comprising a generally square axial recess formed therein that is sized appropriately to releasably receive a drive tang from a torque-imparting driving tool.

15. The bolt and nut removal tool of claim 14, wherein said body first end generally square axial recess communicates with said body central bore.

16. The bolt and nut removal tool of claim 10, wherein said third face wall is angled radially inward with respect to said central longitudinal axis from said body first end toward said body second end.
